(19) United States
(12) Patent Application Publication
(10) Pub. No.: US 2002/0059635 A1
(43) Pub. Date: May 16, 2002

(54) Digital data-on-demand broadcast cable modem termination system

(76) Inventor: Khoi N. Hoang, Pleasanton, CA (US)

Correspondence Address: OPPENHEIMER WOLFF & DONNELLY, P. O. BOX 10356, PALO ALTO, CA, 94303, US

(21) Appl. No.: 09/967,749

(22) Filed: Sep. 27, 2001

Related U.S. Application Data
(63) Continuation-in-part of application No. 09/584,832, filed on May 31, 2000.
(63) Continuation-in-part of application No. 09/709,948, filed on Nov. 10, 2000.
(63) Continuation-in-part of application No. 09/841,792, filed on Apr. 24, 2001.
(63) Continuation-in-part of application No. 09/870,879, filed on May 30, 2001.
(63) Continuation-in-part of application No. 09/892,015, filed on Jun. 25, 2001.
(63) Continuation-in-part of application No. 09/892,017, filed on Jun. 25, 2001.
(63) Continuation-in-part of application No. 09/902,503, filed on Jul. 9, 2001.
(63) Continuation-in-part of application No. 09/933,696, filed on Aug. 20, 2001.

(51) Int. Cl. H04N 7/173

(52) U.S. Cl. 725/111

(57) ABSTRACT

The present invention teaches methods and systems for providing a cable modem termination system (CMTS) for enabling a data-on-demand (DOD) digital broadcast system to provide digital DOD services via a communications medium over one or more channels, the cable modem termination system comprising: a communications network interface for receiving at least one DOD service from the DOD digital broadcast system, wherein the DOD service is formatted as a stream of data blocks arranged in a schedule such that a first data block of the DOD service may be accessed at any selected time period; a unidirectional network interface for providing the stream of data blocks to a plurality of users, wherein the users may access the first data block at any time period and may access subsequent data blocks of the stream of data blocks thereby accessing the at least one DOD service.

### RELATED APPLICATION

This application is a continuation-in-part claiming priority to Khoi Hoang's patent applications entitled SELECTIVE INACTIVATION AND COPY-PROTECTION, filed on Aug. 20, 2001, bearing Attorney Docket Number 60595-301001, CONTROLLING DATA-ON-DEMAND CLIENT ACCESS, filed on Jul. 9, 2001, bearing application Ser. No. 09/902,503, DECREASED IDLE TIME AND CONSTANT BANDWIDTH DATA-ON-DEMAND BROADCAST DELIVERY MATRICES, filed on Jun. 25, 2001, bearing application Ser. No. 09/892,017, COUNTERFEIT STB PREVENTION THROUGH PROTOCOL SWITCHING, filed on Jun. 25, 2001, bearing application Ser. No. 09/892,015, UNIVERSAL STB ARCHITECTURES AND CONTROL METHODS filed on May 30, 2001, bearing application Ser. No. 09/870,879, NON CLIENT SPECIFIC ON-DEMAND DATA BROADCAST (Amended) filed on May 31, 2000, bearing application Ser. No. 09/584,832, METHODS FOR PROVIDING VIDEO-ON-DEMAND SERVICES FOR BROADCASTING SYSTEMS filed Nov. 10, 2000, bearing application Ser No. 09/709,948 and UNIVERSAL DIGITAL BROADCAST SYSTEM AND METHODS filed on Apr. 24, 2001, bearing application Ser. No. 09/841,792, all eight being incorporated herein by reference.

### BRIEF DESCRIPTION OF THE INVENTION

The present invention relates to video-on-demand and digital broadcast technology. In particular, the present invention teaches a digital broadcast system cable modem termination system for use in both uni-directional and bi-directional data-on-demand (DOD) digital broadcast networks.

### BACKGROUND OF THE INVENTION

A variety of mechanisms are available for delivering data-on-demand (DOD) services over existing cable television lines and over fiber optic networks. Such systems incorporating existing cable television distribution systems are referred to as data over cable systems. These methods all require expensive and complex equipment due to the need to provide a large volume of data to individual customers. Existing cable networks can transmit data in excess of 30 Mbps over an individual 6 MHz physical transmission channel. In the case of DOD service providers, a large volume of data is transmitted to individual customers via a “headend” or data distribution hub. The headend distributes individual DOD services to customers through a cable network and receives request from individual customers for desired DOD services.

PRIOR ART FIG. 1 shows an exemplary DOD digital broadcast distribution system at 10 in accordance with existing methods for providing DOD services. A DOD broadcast server system 12 transmits DOD services to a headend 14 via a data network 16. The data network is typically a network of fiber optic cables implementing asynchronous transfer mode (ATM) transmission protocols, but may also include the internet, satellite transmission networks, telephone transmission networks or dedicated electrical cable networks, either individually or in combination. Each DOD service is transmitted by the DOD server system 12 as a temporally linear stream of data.

A cable modem termination system (CMTS) 18 receives the transmitted DOD services via a CMTS-Network system interface 20. The CMTS 18 then routes selected DOD services to selected cable modem receivers 22 via a cable network 24. The cable network is typically an existing cable television transmission network having a co-axial cable infrastructure, though satellite, telephone and fiber optic networks may also be used. Alternatively, a wide area network (WAN) or local area network (LAN) may be used instead of a cable network. A user may access the selected DOD service via a computer system 26 connected to the cable modem 22.

Users request desired DOD services to be received via the computer 26. The request is transmitted by the cable modem 22 to the CMTS 18 via an upstream channel of the cable network 24. Alternatively the cable modem 22 may have a direct connection to the CMTS via a wireless connection, a satellite connection, or a connection via other technologies to send data upstream outside of the downstream cable transmission path.

The CMTS system 18 receives the DOD service requests indicating DOD services to be addressed to individual cable modems 22. A single headend 14 may serve hundreds of DOD service users, each having one or more cable modems 22. The headend 14 must maintain a database of all receiving cable modems 22 located downstream from itself.

The CMTS 18 sends a request back to the DOD broadcast system 12. The DOD broadcast service system then transmits all requested DOD services to the CMTS 18 for distribution. The CMTS then addresses each downloaded DOD service with the individual address of the requesting user and transmits the DOD service.

PRIOR ART FIG. 2 is a schematic block diagram of the CMTS 18 in accordance with the DOD distribution system illustrated in PRIOR ART FIG. 1. The CMTS system 18 typically includes: a processor 50; memory 52; a bi-directional communication interface 58 and an upstream/downstream bi-directional interface 60, with each component communicatively coupled to each other via a system bus 62. The processor 50 stores the addresses of all downstream cable modems 22 (FIG. 1) in an address table (not shown) within the memory 52. The processor receives DOD service requests from individual users via the upstream/downstream bi-directional interface 60. These requests are forwarded to the DOD broadcast system 12 (FIG. 1) via the bi-directional communications interface 58.

DOD services downloaded from the DOD broadcast system are transmitted to the cable network 24 (FIG. 1) via the upstream/downstream bi-directional interface 60. Each transmitted DOD service is addressed to reach the appropriate user or users.

PRIOR ART FIG. 3 shows a process at 80 performed by the cable modem termination system (CMTS) of PRIOR ART FIG. 2, for providing DOD services to users. The process 80 begins at step 82 at which the CMTS unit receives a request for a selected DOD service from a user via the cable modem 22 and the upstream channel of the cable network 24. Then at step 84 the CMTS unit relays the DOD service request to the DOD server 12 (FIG. 1). In a step 86 the CMTS unit receives the requested DOD service from the DOD server. In a step 88 the CMTS retrieves the requesting users network address from an address table containing the network addresses of all cable modems downstream from the headend 14 (FIG. 1). Retrieving user addresses is a very complex process that involves many individual operations that are not elaborated upon in this description.

In step 90 the CMTS unit addresses the requested DOD service with the network address of the requesting user. Finally in step 92 the CMTS unit transmits the correctly addressed DOD service to the requesting user's cable modem via the cable network. The DOD service transmitted to the requesting user consists of a temporally linear data stream. It must be emphasized that the above is only a very limited description of the complex operations performed by the CMTS.

One problem with existing cable over data systems is that expensive complex bi-directional CMTS systems are required to distribute DOD services to end users. Also, existing bi-directional DOD service distribution networks require a large number of bi-directional CMTS systems, because each CMTS system can only support a limited number of cable modem receivers. Additionally bi-directional DOD services require a greater number of bi-directional CMTS systems because bi-directional DOD distribution systems require a relatively large bandwidth.

What is needed is a uni-directional CMTS system capable of distributing unidirectional broadcast DOD services to a greater number of end users than existing bi-directional CMTS units. Also needed is a uni-directional CMTS that is less complex and expensive than existing bi-directional CMTS units. What is further needed is a unidirectional DOD broadcast service using fewer uni-directional CMTS systems using less transmission bandwidth than conventional bi-directional systems.

### SUMMARY OF THE INVENTION

Certain embodiments of the present invention teache methods and systems for providing a uni-directional cable modem termination system (CMTS) capable of distributing DOD services to a greater number of end users than prior bi-directional CMTS units. Additionally the present invention provides for a uni-directional CMTS unit that is less complex and less expensive than previous bi-directional CMTS units. Furthermore the present invention provides a uni-directional CMTS system capable of distributing more DOD services to more users on less bandwidth than conventional bi-directional DOD CMTS systems.

A first embodiment of the present invention teaches a cable modem termination system (CMTS) for enabling a data-on-demand (DOD) digital broadcast system to provide digital DOD services via a communications medium over one or more channels, the cable modem termination system comprising: an communications network interface for receiving at least one DOD service from the DOD digital broadcast system, wherein the DOD service is formatted as a stream of data blocks arranged in a schedule such that a first data block of the DOD service may be accessed at any selected time period; a downstream network interface for providing the stream of data blocks to a plurality of users, wherein the users may access the first data block at any time period and may access subsequent data blocks of the stream of data blocks thereby accessing the at least one DOD service.

According to another embodiment of the present invention, the at least one DOD service is at least one plurality of DOD services formatted as a stream of data blocks arranged in a schedule such that a first data block of any one of the at least one plurality of DOD services may be accessed at any selected time period, and wherein a user may access subsequent data blocks of the any one of the at least one plurality of DOD services thereby accessing any one of the plurality of DOD services. Also disclosed is a cable modem termination system, wherein the downstream network interface is communicatively coupled to a plurality of set-top-boxes via a cable network

Another aspect of the present invention teaches a cable modem termination system (CMTS) method for providing data-on-demand (DOD) digital services via a communications medium over one or more channels, the cable modem termination system method comprising the acts of: receiving at least one DOD service from a DOD broadcast system, wherein the DOD service is formatted as a stream of data blocks arranged in a schedule such that a first data block of the DOD service may be accessed at any selected time period; transmitting the stream of data blocks to a plurality of users, wherein the users may access the first data block at any time period and may access subsequent data blocks of the stream of data blocks thereby accessing the at least one DOD service

### BRIEF DESCRIPTION OF THE DRAWINGS

PRIOR ART FIG. 1 is a schematic block diagram generally illustrating an exemplary DOD digital broadcast distribution system;

PRIOR ART FIG. 2 is a schematic block diagram of a cable modem termination system (CMTS) in accordance with the DOD distribution system illustrated in PRIOR ART FIG. 1;

PRIOR ART FIG. 3 is a flow chart diagram generally illustrating a process performed by the cable modem termination system (CMTS) of PRIOR ART FIG. 2 for providing DOD services to users;

FIG. 4 is a schematic block diagram generally illustrating a digital data on demand (DOD) broadcast system in accordance with one embodiment of the present invention;

FIG. 5 is a schematic block diagram generally illustrating DOD broadcast server incorporating a unidirectional CMTS in accordance with one embodiment of the present invention;

FIG. 6 is a schematic block diagram illustrating the architecture for the DOD cable modem termination system (CMTS) in accordance with the present invention;

FIG. 7 is a flow chart diagram generally illustrating the process performed by the CMTS system of FIG. 6 for distributing DOD services; and

FIG. 8 is a schematic block diagram generally illustrating a universal set-top-box (STB) in accordance with one embodiment of the invention.

### DETAILED DESCRIPTION OF THE INVENTION

In the following detailed description of the embodiments, reference is made to the drawings that accompany and that are a part of the embodiments. The drawings show, by way of illustration, specific embodiments in which the invention may be practiced. Those embodiments are described in sufficient detail to enable those skilled in the art to practice the invention and it is to be understood that other embodiments may be utilized and that structural, logical, and electrical changes as well as other modifications may be made without departing from the spirit and scope of the present invention.

Preferred embodiments teach methods and systems for providing a less expensive uni-directional cable modem termination systems (CMTS) capable of distributing DOD services to a greater number of end users than prior bi-directional CMTS units. More specifically the present invention teaches methods and systems for providing a uni-directional cable modem termination system (CMTS) for enabling a data-on-demand (DOD) digital broadcast system to provide digital DOD services via a communications medium over one or more channels, the cable modem termination system comprising: a communications interface for receiving at least one DOD service from the DOD digital broadcast system, wherein the DOD service is formatted as a stream of data blocks arranged in a schedule such that a first data block of the DOD service may be accessed at any selected time period; a downstream network interface for providing the stream of data blocks to a plurality of users, wherein the users may access the first data block at any time period and may access subsequent data blocks of the stream of data blocks thereby accessing the at least one DOD service.

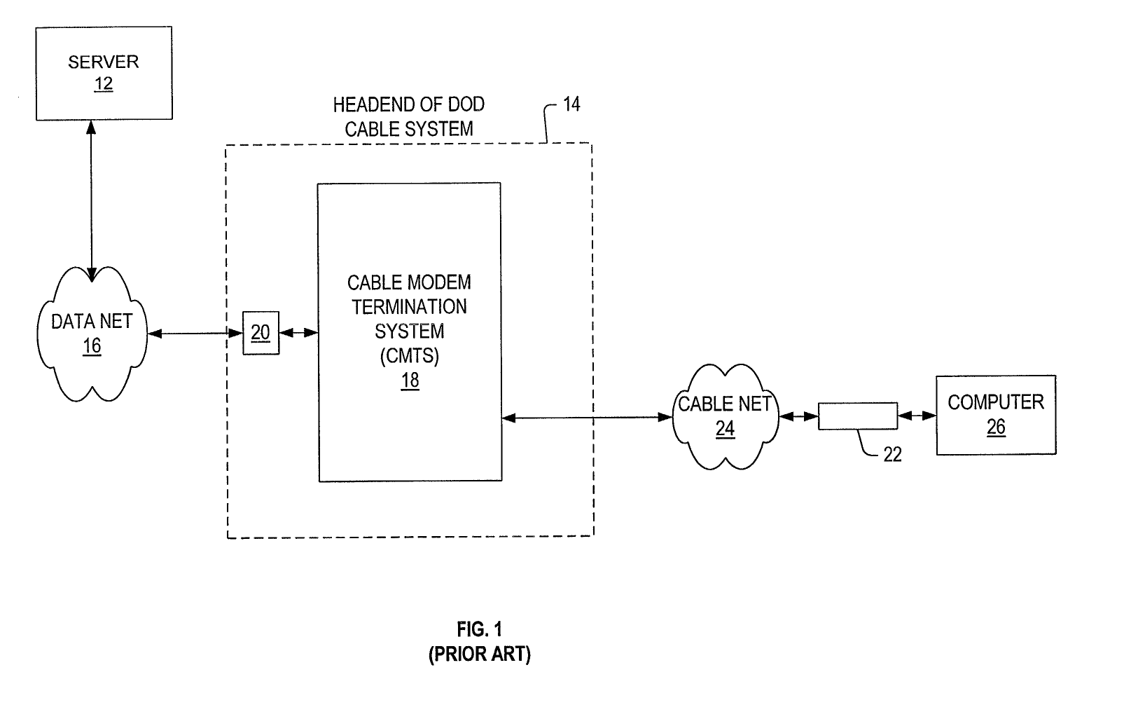

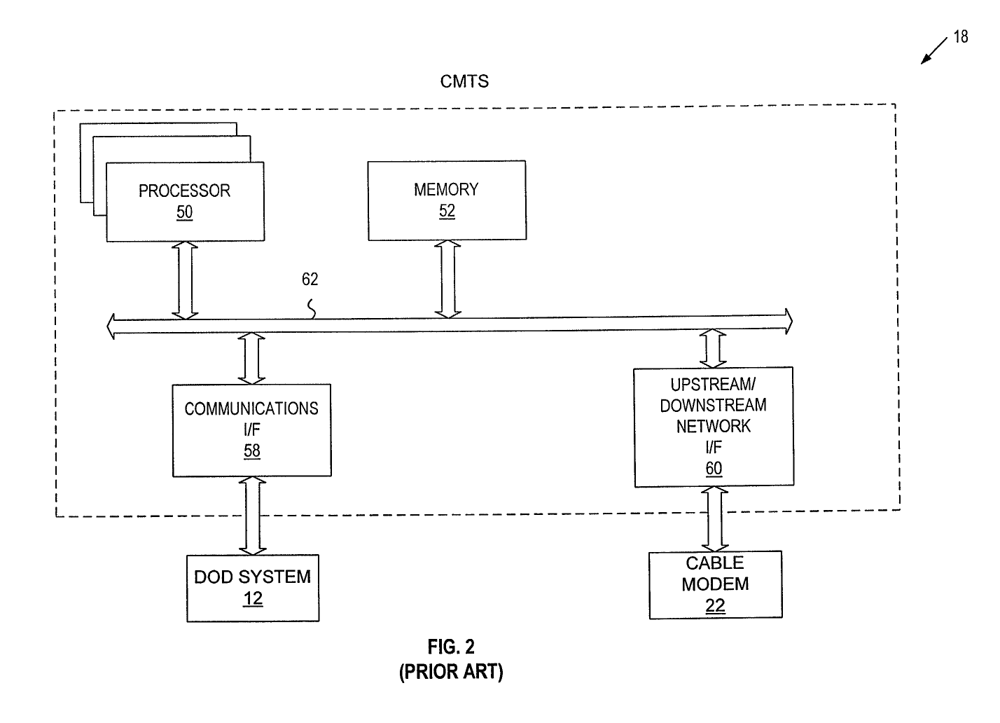

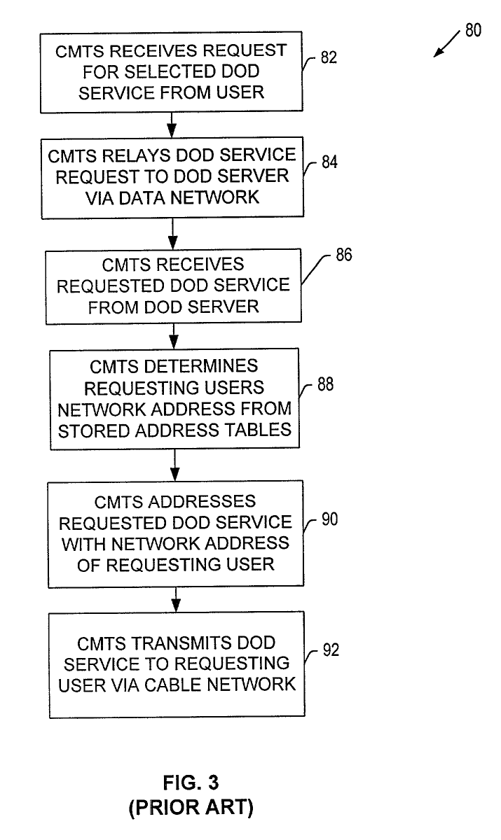

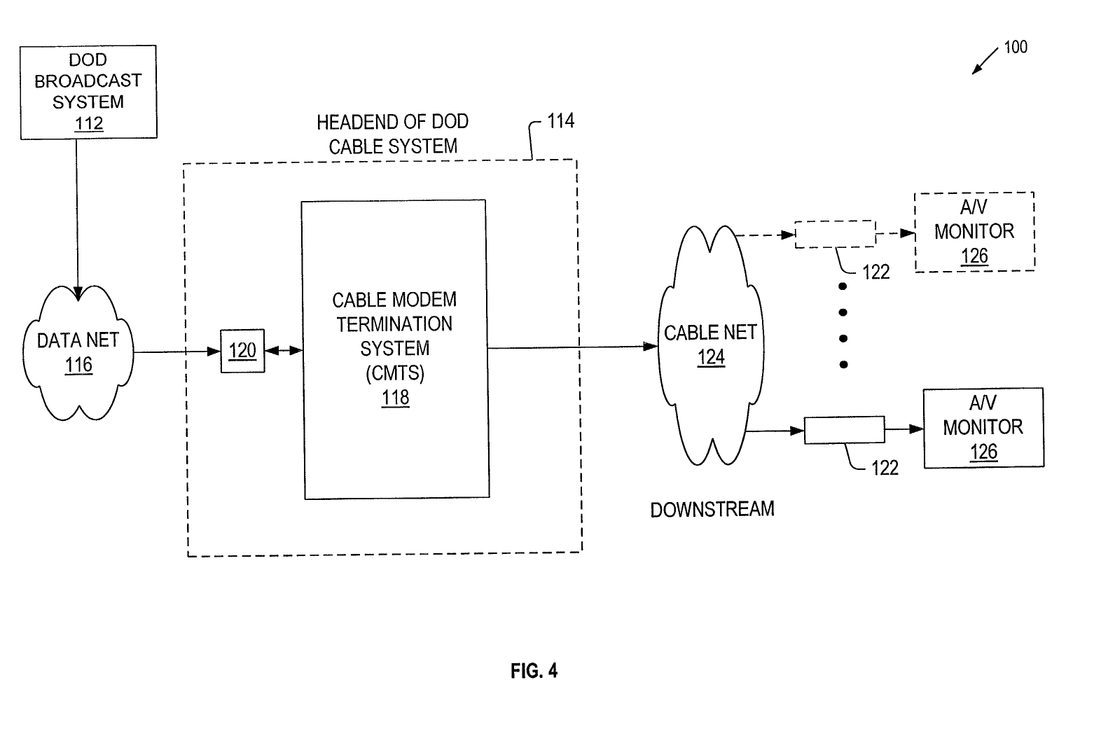

FIG. 4 is a schematic block diagram illustrating a digital data on demand (DOD) broadcast system at 100 in accordance with one embodiment of the present invention. The DOD broadcast system 100 is comprised of: a DOD broadcast server 112; a broadcast data network 116; a plurality of headend units 114, each containing a CMTS-Network system interface 120 and a CMTS unit 118; a cable network 124; a plurality of set-top-box (STB) DOD receivers 122; and a plurality of audio visual (A/V) display units 126.

DOD broadcast server 112 transmits all available DOD services within one or more DOD data streams. In an exemplary embodiment the DOD broadcast server also transmits cable television signals in addition to DOD services. The number of DOD data streams is dependent on the bandwidth of a cable channel (e.g., 6, 6.5, or 8 MHz), QAM modulation (e.g., QAM 64 or QAM 256), and a compression standard/bit rate of the DOD data stream (e.g., MPEG-1 or MPEG-2). Each DOD service is transmitted as multiple data blocks (TO-Tx) arranged in accordance with a scheduling matrix. The data blocks are transmitted so that at any time a receiving STB 122 may begin accessing any DOD service's TO data block and continue receiving each subsequent data block comprising the selected DOD service. Unlike prior DOD broadcast systems 10, the sequence of transmitted data blocks is not temporally linear, and some data blocks of a selected DOD service are transmitted more often than others.

This method of broadcasting DOD services is discussed in detail in Khoi Nhu Hoang's patent applications entitled UNIVERSAL STB ARCHITECTURES AND CONTROL METHODS filed on May 30, 2001, SYSTEMS AND METHODS FOR PROVIDING VIDEO ON DEMAND SERVICES FOR BROADCASTING SYSTEMS filed on May 31, 2000, bearing application Ser No. 09/584,832, METHODS FOR PROVIDING VIDEO ON DEMAND SERVICES FOR BROADCASTING SYSTEMS filed Nov. 10, 2000, bearing application Ser. No. 09/709,948 and UNIVERSAL DIGITAL BROADCAST SYSTEM AND METHODS filed on Apr. 24, 2001, bearing application Ser. No. 09/841,792, each of which is hereby incorporated by reference.

The data network 116 transmits the DOD data streams to the headend of the cable system 114. The data network 116 may include a fiber optic transmission system or any transmission system capable of transmitting large data streams such as satellite transmission systems.

The cable modem termination system (CMTS) 112 receives this DOD data stream via the CMTS-Network interface system 120. In an exemplary embodiment the CMTS-Network interface system 120 establishes a link between the CMTS 118 and the DOD broadcast system 112 in order to facilitate transmission of the DOD data stream.

The CMTS 118 transmits the DOD data streams to each downstream set-top-box (STB) DOD receiver 122 via the cable network 124. Each STB receiver 122 receives identical streams of DOD data.

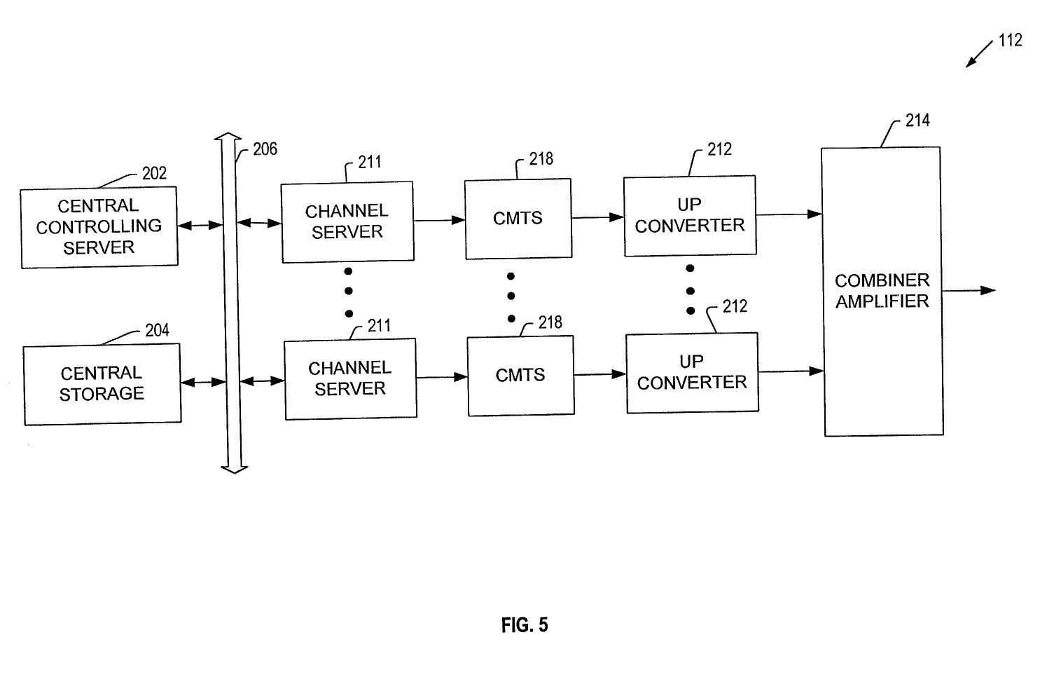

FIG. 5 illustrates the architecture for a DOD broadcast server at 112 incorporating a uni-directional CMTS unit in accordance with one embodiment of the present invention. By incorporating the CMTS unit in the DOD broadcast server system, the need for a separate headend is eliminated. The DOD server 112 includes a plurality of channel servers 211, a plurality of unidirectional CMTS units, a plurality of up converters 212 each corresponding to a channel server 211, a combiner amplifier 214, a central controlling server 202, and a central storage 204, coupled as illustrated through a data bus 206. As will be described below, the central controlling server 202 controls offline operation of the channel servers 211, as well as initiating real-time transmission once the channel servers 211 are ready. The central storage 204 typically stores data files in a digital format. However, any suitable mass persistent data storage device may be used.

In an exemplary embodiment, data files stored in the central storage 204 are accessible via a standard network interface (e.g., Ethernet connection) by any authorized computer, such as the central controlling server 202, connected to the network. The channel servers 211 provide data files that are retrieved from the central storage 204 in accordance with instructions from the central controlling server 202. The retrieval of digital data and the scheduling of transmission of the digital data for DOD is performed “off-line” to fully prepare each channel server 211 for real-time data transmission. Each channel server 211 informs the central controlling server 202 when ready to provide DOD, at which point the central controlling server 202 can control the channel servers 211 to begin DOD transmission.

In a preferred embodiment, the central controlling server 202 includes a graphics user interface (not shown) to enable a service provider to schedule data delivery by a drag-and-drop operation. Further, the central controlling server 202 authenticates and controls the channel servers 210 to start or stop according to delivery matrices. Systems and methods for providing uni-directional DOD broadcast matrices are taught in Khoi Hoang's patent application entitled SYSTEMS AND METHODS FOR PROVIDING VIDEO ON DEMAND SERVICES FOR BROADCASTING SYSTEMS filed on May 31, 2000, bearing application ser. No. 09/584,832, which is incorporated herein by reference.

Each channel server 211 is assigned to a channel and is coupled to a uni-directional CMTS unit 218, which transmits the DOD information to each up-converter 212. The output of each CMTS unit 218 is a quadrature amplitude modulation (QAM) modulated intermediate frequency (IF) signal having a suitable frequency for the corresponding up-converter 212. The QAM-modulated IF signals are dependent upon adopted standards. The current adopted standard in the United States is the data-over-cable-systems-interface-specification (DOCSIS) standard, which requires an approximately 43.75 MHz IF frequency.

The up-converters 212 convert IF signals received from the CMTS units 218 to radio frequency signals (RF signals). The RF signals, which include frequency and bandwidth, are dependent on a desired channel and adopted standards. For example, under the current standard in the United States for a cable television channel 80, the RF signal has a frequency of approximately 559.25 MHz and a bandwidth of approximately 6 MHz.

The outputs of the up-converters 212 are applied to the combiner/amplifier 214. The combiner/amplifier 214 amplifies, conditions and combines the received RF signals then outputs the signals out to the data network 116 (FIG. 4).

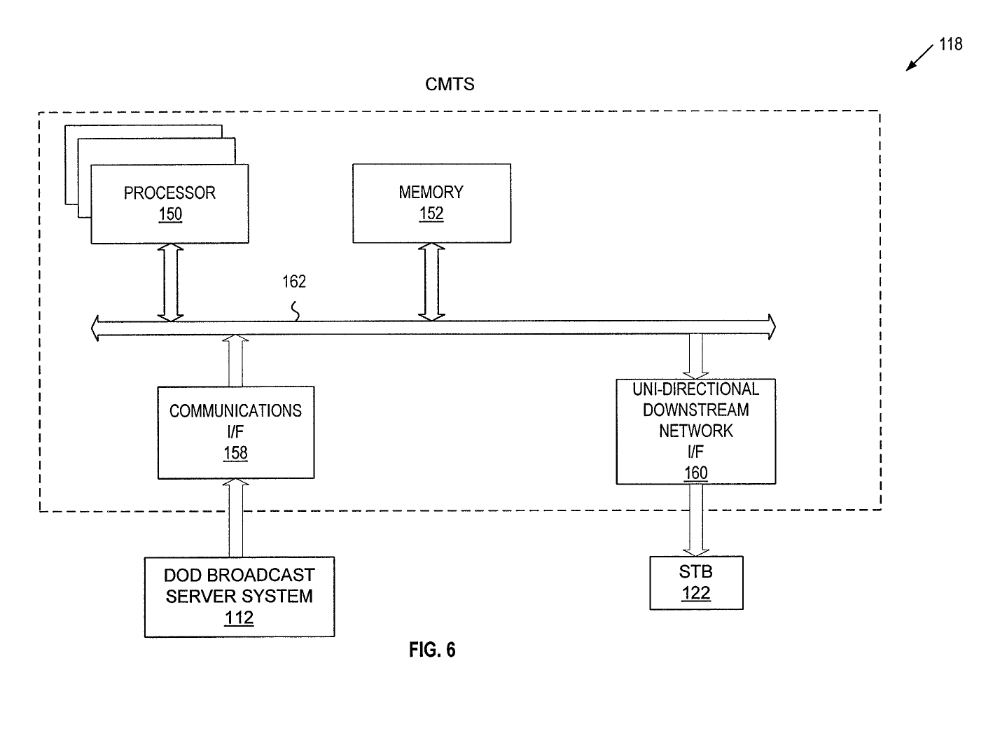

FIG. 6 illustrates the architecture for a uni-directional DOD cable modem termination system at 118 in accordance with one embodiment of the present invention. The CMTS system 118 includes: a processor 150; memory 152; a communications network interface 158 and a uni-directional downstream interface 160, with each component communicatively coupled to each other via a system bus 162. DOD services received from the DOD broadcast system via the data network 116 (FIG. 4) are transmitted to the cable network 124 (FIG. 4) via the communications network interface 160. The entire data stream of DOD services is transmitted to each STB 122 via the cable network 124. An individual user may access any DOD service that the user's STB 122 is authorized to access.

Unlike previous bidirectional CMTS 18 (FIG. 1) units, the unidirectional CMTS 118 of the present invention simply passes all received DOD data down stream to all STBs 122 connected to the cable network 124. Because all available DOD services are transmitted to all STBs 122, there is no need for the CMTS 118 to route individual DOD services to individual users. There is also no need to receive data from the end users. The primary function of the processor 102 is to maintain communication with the DOD broadcast server system 112. No address tables are stored by the CMTS 118 and no upstream communications from users are received by the CMTS unit. In an exemplary embodiment the CMTS unit also relays digital cable television signals from the server system 112 to all downstream users.

A stream of DOD data is received by the communications network interface 112 and transmitted in a format suitable for display by downstream network interface 118 to all STBs 122 via the cable network 124. In an exemplary embodiment the downstream network interface 160 transmits the DOD data stream in a QAM-modulated IF stream suitable for broadcast over the cable network. No communications are received by the uni-directional CMTS system from the STBs. In an exemplary embodiment the DOD data stream signal strength is amplified to assure a clear signal reaches all downstream users.

The uni-directional CMTS 118 of the present invention is capable of supporting many more downstream users than previous systems, because individual DOD services are not routed to individual users. Also, many more users may be supported because the CMTS 118 does not process upstream requests from users for selected DOD services.

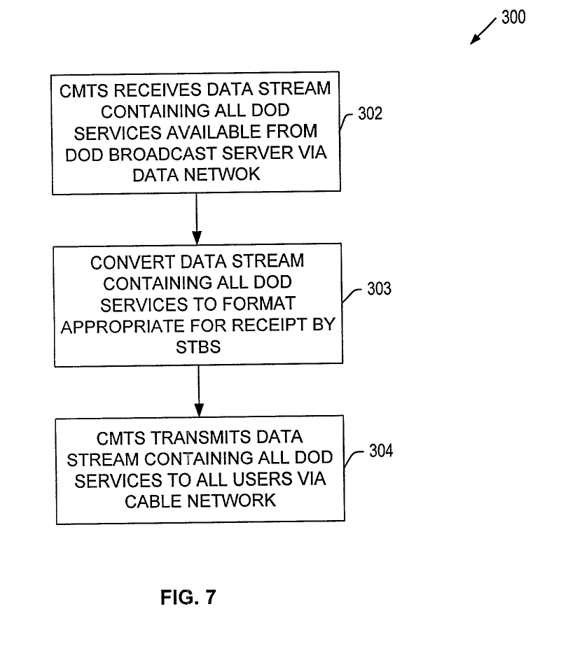

FIG. 7 illustrates a CMTS process at 300 for distributing DOD services in accordance with one embodiment of the present invention. At step 302 the CMTS 118 (FIG. 4) receives one or more data streams containing all DOD services available from the DOD broadcast server system 112 (FIG. 1) via the data network 116. The DOD data streams having been formatted in a sequence of data blocks such that any DOD service may be accessed at any starting time.

In a step 303 the uni-directional CMTS converts the DOD data streams to a format suitable for access by receiving STBs 122. In an exemplary embodiment the DOD data streams are formatted to a QAM-Modulated IF frequency signal such as QAM 64 or QAM 256.

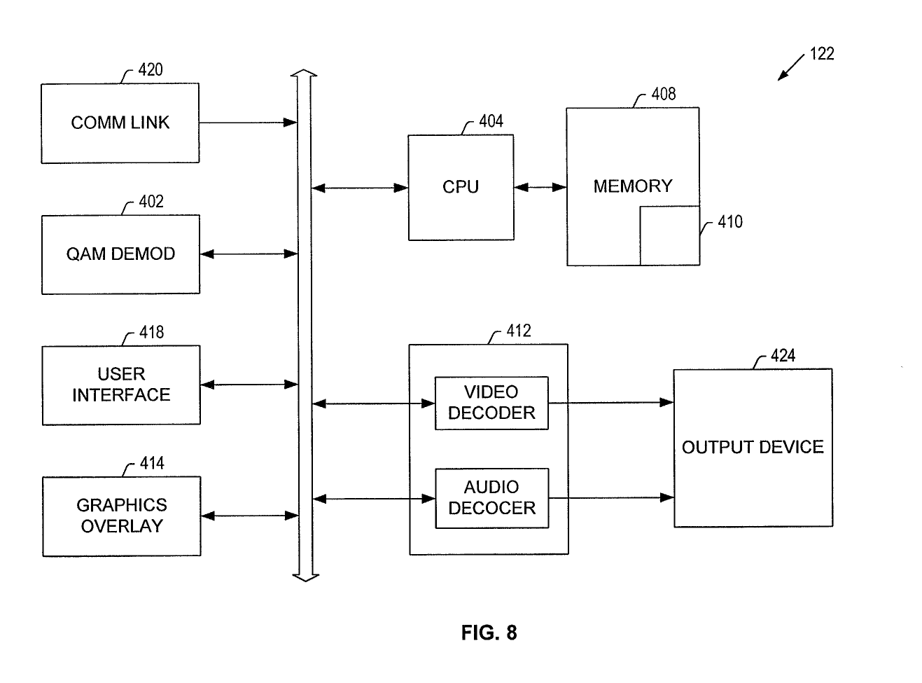

In a step 304 the CMTS 118 (FIG. 4) transmits all received DOD data streams to all downstream STBs 122 via the cable network 124 (FIG. 4) such that each receiving STB may access any available DOD service. In an exemplary embodiment, wherein the DOD service is a temporally linear video presentation such as a movie, a user may access the presentation from the beginning at any time period. For example, a user is able to view the movie “Star Wars” from the beginning of the movie at any time the user selects FIG. 8 illustrates a universal STB 122 in accordance with one embodiment of the invention. The STB 122 comprises a QAM demodulator 402, a CPU 404, a local memory 408, a buffer memory 410, a decoder 412 having video and audio decoding capabilities, a graphics overlay module 414, a user interface 418, a communications link 420, and a fast data bus 422 coupling these devices as illustrated. The CPU 402 controls overall operation of the universal STB 400 in order to select data in response to a client's request, decode selected data, decompress decoded data, re-assemble decoded data, store decoded data in the local memory 408 or the buffer memory 410, and deliver stored data to the decoder 412. In an exemplary embodiment, the local memory 408 comprises both non-volatile memory (e.g., a hard drive) and secure memory (e.g., a ROM chip), and the buffer memory 410 comprises volatile memory.

In one embodiment, the QAM demodulator 402 comprises transmitter and receiver modules and one or more of the following: privacy encryption/decryption module, forward error correction decoder/encoder, tuner control, downstream and upstream processors, CPU and memory interface circuits. The QAM demodulator 402 receives modulated IF signals, samples and demodulates the signals to restore data.

In an exemplary embodiment, when access is granted, the decoder 412 decodes at least one data block to transform the data block into images displayable on an output screen. The decoder 412 supports commands from a subscribing client, such as play, stop, pause, step, rewind, forward, etc. The decoder 412 provides decoded data to an output device 624 for use by the client. The output device 424 may be any suitable device such as a television, computer, any appropriate display monitor, a VCR, or the like.

The graphics overlay module 414 enhances displayed graphics quality by, for example, providing alpha blending or picture-in-picture capabilities. In an exemplary embodiment, the graphics overlay module 414 can be used for graphics acceleration during game playing mode, for example, when the service provider provides games-on-demand services using the system in accordance with the invention.

The user interface 418 enables user control of the STB 122, and may be any suitable device such as a remote control device, a keyboard, a smartcard, etc. The communications link 420 provides an additional communications connection. This may be coupled to another computer, or may be used to implement bi-directional communication. The data bus 422 is preferably a commercially available “fast” data bus suitable for performing data communications in a real time manner as required by the present invention. Suitable examples are USB, firewire, etc. Although services are broadcast to all cable television subscribers, only the DOD subscriber who has an STB 122 authorized to view a selected DOD service will be able to decode and enjoy the selected service. The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

What is claimed is:

1. A uni-directional cable modem termination system (CMTS) comprising:
a communications interface for receiving data transmissions; and
a uni-directional interface for providing data transmissions, wherein said cable modem termination system does not require upstream communications.

2. A uni-directional cable modem termination system (CMTS) as recited in claim 1, wherein said communications interface is further operative for receiving at least one data file from a digital broadcast system, wherein said data file is formatted as a stream of data blocks arranged in a schedule such that a first data block of said data file may be accessed at any selected time period; and wherein said uni-directional interface is further operative for providing said stream of data blocks to a plurality of users, and wherein said users may access said first data block at any time period and may access subsequent data blocks of said stream of data blocks thereby accessing said at least one data file.

3. A uni-directional cable modem termination system as recited in claim 2, wherein said at least one data file is at least one plurality of data files formatted as a stream of data blocks arranged in a schedule such that a first data block of any one of said at least one plurality of data files may be accessed at any selected time period, and wherein a user may access subsequent data blocks of said any one of said at least one plurality of data files thereby accessing said any one of said plurality of data files.

4. A uni-directional cable modem termination system as recited in claim 2, wherein said accessing said at least one data file by said users includes displaying at least a portion of a graphical representation of at least one of said data blocks.

5. A uni-directional cable modem termination system as recited in claim 3, wherein said downstream network interface is communicatively coupled to a plurality of set-top-boxes via a cable network.

6. A uni-directional cable modem termination system as recited in claim 5, wherein said set-top-boxes include an audi-visual display apparatus for displaying at least a portion of at least one of said data files.

7. A uni-directional cable modem termination system as recited in claim 5, wherein said downstream network interface may not receive data from said plurality of set-top-boxes.

8. A uni-directional cable modem termination system as recited in claim 3, wherein said cable modem termination system is incapable of receiving information from said user.

9. A uni-directional cable modem termination system as recited in claim 5, wherein said cable modem termination system is uni-directionally coupled to said plurality of set-top-boxes.

10. A uni-directional cable modem termination system as recited in claim 2, wherein said communications interface is operative to receive digitally encoded data, and wherein said uni-directional network interface is operative to transmit said received digitally encoded data.

11. A unidirectional cable modem termination system as recited in claim 2, wherein said uni-directional network interface provides said stream of data blocks as electronic signals.

12. A uni-directional cable modem termination system as recited in claim 2, wherein said communications interface is operative to receive data from a server system, and wherein at least one of said plurality of set-top-boxes is operative to communicate with said server system via a communications medium.

13. A uni-directional cable modem termination system as recited in claim 12, wherein said communications medium includes a telephone network.

14. A uni-directional cable modem termination system as recited in claim 12, wherein said communications medium includes a wireless network.

15. A uni-directional cable modem termination system as recited in claim 12, wherein said communications medium includes the internet.

16. A cable modem termination system (CMTS) for enabling a data-on-demand (DOD) digital broadcast system to provide digital DOD service via a communications medium over one or more channels, said cable modem termination system comprising:
an communications network interface for receiving at least one DOD service from said DOD digital broadcast system, wherein said DOD service is formatted as a stream of data blocks arranged in a schedule such that a first data block of said DOD service may be accessed at any selected time period;
a uni-directional network interface for providing said stream of data blocks to a plurality of users, wherein said users may access said first data block at any time period and may access subsequent data blocks of said stream of data blocks thereby accessing said at least one DOD service.

17. A cable modem termination system as recited in claim 16, wherein said at least one DOD service is at least one plurality of DOD services formatted as a stream of data blocks arranged in a schedule such that a first data block of any one of said at least one plurality of DOD services may be accessed at any selected time period, and wherein a user may access subsequent data blocks of said any one of said at least one plurality of DOD services thereby accessing said any one of said plurality of DOD services.

18. A cable modem termination system as recited in claim 16, wherein said accessing said at least one DOD service by said users includes displaying at least a portion of a graphical representation of at least one of said data blocks.

19. A cable modem termination system as recited in claim 17, wherein said uni-directional network interface is communicatively coupled to a plurality of set-top-boxes via a cable network.

20. A cable modem termination system as recited in claim 19, wherein said set-top-boxes include an audi-visual display apparatus for displaying at least a portion of at least one of said DOD services.

21. A cable modem termination system as recited in claim 19, wherein said uni-directional network interface may not receive data from said plurality of set-top-boxes.

22. A cable modem termination system as recited in claim 17, wherein said cable modem termination system is incapable of receiving information from said user.

23. A cable modem termination system as recited in claim 19, wherein said cable modem termination system is uni-directionally coupled to said plurality of set-top-boxes.

24. A cable modem termination system as recited in claim 16, wherein said communications network interface is operative to receive digitally encoded data, and wherein said uni-directional network interface is operative to transmit said received digitally encoded data.

25. A universal broadcast system as recited in claim 16, wherein said uni-directional network interface provides said stream of data blocks as electronic signals.

26. A cable modem termination system (CMTS) method for providing data-on-demand (DOD) digital services via a communications medium over one or more channels, said cable modem termination system method comprising the acts of:
receiving at least one DOD service from a DOD broadcast system, wherein said DOD service is formatted as a stream of data blocks arranged in a schedule such that a first data block of said DOD service may be accessed at any selected time period;
transmitting said stream of data blocks to a plurality of users, wherein said users may access said first data block at any time period and may access subsequent data blocks of said stream of data blocks thereby accessing said at least one DOD service.

27. A method as recited in claim 26, wherein said at least one DOD service is at least one plurality of DOD services formatted as a stream of data blocks arranged in a schedule such that a first data block of any one of said at least one plurality of DOD services may be accessed at any selected time period, and wherein a user may access subsequent data blocks of said any one of said at least one plurality of DOD services thereby accessing said any one of said plurality of DOD services.

28. A method as recited in claim 26, wherein said accessing said at least one DOD service by said users includes displaying at least a portion of a graphical representation of at least one of said data blocks.

29. A method as recited in claim 12, wherein said stream of data blocks is transmitted to a plurality of set-top-boxes via a cable network.

30. A method as recited in claim 29, wherein said set-top-boxes include an audio-visual display apparatus for displaying at least a portion of at least one of said DOD services.

31. A method as recited in claim 29, wherein said method excludes receiving data from said plurality of set-top-boxes.

32. A method as recited in claim 27, wherein said stream of data blocks is transmitted to said plurality of set-top-boxes as an electronic signal.

33. A method as recited in claim 32, further comprising amplifying said stream of data blocks.

34. A method as recited in claim 29, wherein said set-top-boxes include advanced television receivers having internal set-top-boxes.

35. A method as recited in claim 29, further including receiving digitally encoded data and transmitting said digitally encoded data via said cable network.

36. A cable modem termination system (CMTS) for enabling a data-on-demand (DOD) digital broadcast system to provide digital DOD services via a communications medium over one or more channels, said cable modem termination system comprising:
a first means for receiving at least one DOD service from said DOD digital broadcast system, wherein said DOD service is formatted as a stream of data blocks arranged in a schedule such that a first data block of said DOD service may be accessed at any selected time period;
a second means for providing said stream of data blocks to a plurality of users, wherein said users may access said first data block at any time period and may access subsequent data blocks of said stream of data blocks thereby accessing said at least one DOD service.

37. A cable modem termination system as recited in claim 36, wherein said at least one DOD service is at least one plurality of DOD services formatted as a stream of data blocks arranged in a schedule such that a first data block of any one of said at least one plurality of DOD services may be accessed at any selected time period, and wherein a user may access subsequent data blocks of said any one of said at least one plurality of DOD services thereby accessing said any one of said plurality of DOD services.

38. A cable modem termination system as recited in claim 36, wherein said accessing said at least one DOD service by said users includes displaying at least a portion of a graphical representation of at least one of said data blocks.

39. A cable modem termination system as recited in claim 37, wherein said second means is communicatively coupled to a plurality of set-top-boxes via a cable network.

40. A cable modem termination system as recited in claim 39, wherein said set-top-boxes include an audi-visual display apparatus for displaying at least a portion of at least one of said DOD services.

41. A cable modem termination system as recited in claim 39, wherein said second means may not receive data from said plurality of set-top-boxes.

42. A cable modem termination system as recited in claim 38, wherein said cable modem termination system is incapable of receiving information from said user.

43. A cable modem termination system as recited in claim 39, wherein said cable modem termination system is uni-directionally coupled to said plurality of set-top-boxes.

44. A cable modem termination system as recited in claim 36, wherein said first means is operative to receive digitally encoded data, and wherein said second means is operative to transmit said received digitally encoded data.

45. A universal broadcast system as recited in claim 36, wherein said second means provides said stream of data blocks as electronic signals.
